(19) United States
(12) Patent Application Publication
(10) Pub. No.: US 2014/0009916 A1
(43) Pub. Date: Jan. 9, 2014

(54) Blanket Decorated with Laminated LED Patch

(71) Applicant: Ning Zhang, Markham (CA)

(72) Inventor: Ning Zhang, Markham (CA)

(21) Appl. No.: 13/541,720

(22) Filed: Jul. 4, 2012

(51) Int. Cl. F21V 33/00

(52) U.S. Cl. CPC F21V 33/0004
USPC 362/103

(57) ABSTRACT

This utility discloses a blanket, which includes the body, is characterized in that a decorative laminated patch with LED is connected with the upper surface of the blanket body. The decorative laminated patch has the structure that a light emitting component is composed of a printed circuit board, at least one LED luminotron, and a control circuit with a switch; the light emitting component is arranged in a plastic bag with sealed periphery; the bottom of the plastic bag is a connection surface; the top is a decorative surface; and the position corresponding to the LED luminotron on the decorative surface is a transparent or semitransparent structure. This utility patent provides the assembled blanket with waterproof function laminated patch through arranging the light emitting component and sound components into the plastic bag with sealed periphery, thereby having the advantages of capability of being washable, decorative and amusement.

### TECHNICAL FIELD

This utility patent relates to bedding and in particular to a blanket with decoration and game features.

### BACKGROUND OF THE INVENTION

A blanket is a kind of common bedding. It can be made of any fabric, such as wool, acrylic fibers, synthetic fiber and polyester-cotton.

By taking advantage of LED light emitting circuit or the combination of LED light-emitting circuit and sound circuit, various light-emitting toys, light-emitting sounding toys and various decorations can be made. With the increasing maturity of existing LED light-emitting and control circuit technology, the functions such as the flashing and alternating of LED lights of different colors and radiation of the lights to the changing rhythm of the sound circuit can be easily realized, and the sound circuit containing multiple musical pieces and voices are gradually becoming increasingly small and exquisite. With the power supply from button batteries, this kind of sound and light-emitting circuit can be reduced to the size of several centimeters, and be widely used in the decoration and toy field.

However, problems will occur when attempting to combine the LED light-emitting circuit with blankets to make blankets of decoration features. On the one hand, blankets need to be washed regularly, but being equipped with LED light-emitting circuit will make the washing a great difficulty. On the other hand, when used by the infants, for example, such situations as defecation, regurgitating milk or even spillover of drinking water may lead to water inflowing into the LED light-emitting circuit, resulting in short circuit or the damage of the circuit.

However, since infants are the group who are interested in light-emitting or sounding objects, resolution of the problems mentioned above will expand a broad market for the application of LED light-emitting circuits.

### CONTENTS OF THE INVENTION

The utility patent aims to provide a blanket which can not only provide light-emitting or light-emitting sounding features, but also suitable for the products prone to get wet or need washing, playing a role in decoration.

In order to reach the above aim, the technical scheme adopted for this utility patent is: a blanket, which includes the blanket body and is characterized in that a decorative laminated patch with LED is connected with the upper surface of the blanket body. The decorative laminated patch with LED has the structure that a light emitting component is composed of a printed circuit board, at least one LED luminotron, and a control circuit with a switch; the light emitting component is arranged in a plastic bag with sealed periphery; the bottom of the plastic bag is a connection surface; the top is a decorative surface; and the position corresponding to the LED luminotron on the decorative surface is a transparent or semitransparent structure.

The said light-emitting component is existing technology. The different lighting effects can be realized by setting LED luminotrons of different quantity and colors and changing the output waveform of control circuit, providing the blanket with the entertainment and decoration features. The light-emitting component is arranged in a sealed plastic bag, providing it with water-proof function, and therefore, the blanket can be washed.

In the above technical schemes, to realize the connection between decorative sheet and the blanket, the adopted scheme is: the connection surface of the said plastic bag is fixedly connected with either loop or hook of a Velcro, and the said blanket body is fixedly connected with the hook or loop of a Velcro, and thus connecting the decorative sheet with the blanket body through the Velcro.

Or, configure the outside of the sealed periphery of the said plastic bag with connection edge extending to the surround, and sew the decorative laminated patch with LED to the blanket body fixedly along the suture set on the said connection edge.

Of course, the other methods, such as gluing or snap buttons, can also be used to connect the decorative sheet to a blanket, or the blanket body can be fixed with a transparent bag, into which the decorative sheet can be placed.

In the above technical scheme, LED luminotron can be configured according to the actual needs. An optimized scheme for which is, set up three LED luminotrons, but not limited to 3 LED, which are red, green and yellow, respectively.

In the further technical scheme, the said printed circuit board can also be set up with sound circuit, which can adopt ready-made sounding chip, and work in combination with a micro speaker.

The on-off switch can be controlled by the same on-off button of the light-emitting component.

In the further technical scheme, the said control circuit can also be set up with a delay-off circuit. In use, press the button to switch on the decorative sheet, and after the pre-set time, the decorative sheet will automatically switch off. This structure is particularly suitable for decoration on children's toys, for it can avoid shortening of the service life of batteries caused by long-time working.

Due to the application of the above technical scheme, compared with the existing technologies, this utility patent has the following advantages:
1. By arranging the light-emitting component into a plastic bag with sealed periphery, this utility model has the water-proof functions, and even when attached on blanket, the blanket can still be washed.
2. The top of the plastic bag is a decorative surface, and the corresponding position of LED luminotrons on which is of transparent or semi-transparent structure, achieving different luminous effects. Meanwhile, different decoration patterns can be drawn on the decorative surface, increasing the entertainment and decoration features of the blankets.
3. The bottom of the plastic bag is a connection surface, which can be connected to the blanket through Velcro, sewing and gluing, among which the Velcro structure can also make the removing of the decoration sheet very convenient. Removing the decorative patch for washing will elongate the service life of decorative patch.
4. The utility model is of simple structure, low cost, wide application, making it suitable to be popularized and used.
5. A whole new decoration method for baby blankets.

### DESCRIPTION OF ATTACHED FIGURES

FIG. 1 is the structure diagram of the application case I of the utility patent;

FIG. 2 is the enlarged structure diagram of decorative sheet in FIG. 1;

FIG. 3 is the enlarged structure diagram of Figure II in A-A section side-looking view;

FIG. 4 is the back view diagram of FIG. 2.

FIG. 5 is the diagram of the utility model in application case II.

In which: 1. printed circuit board; 2. LED luminotrons; 3 plastic bag; 4. Velcro; 5. blanket body.

### DETAILED METHOD OF APPLICATION

Further description of the utility model will be given in combination with the figures and application cases.

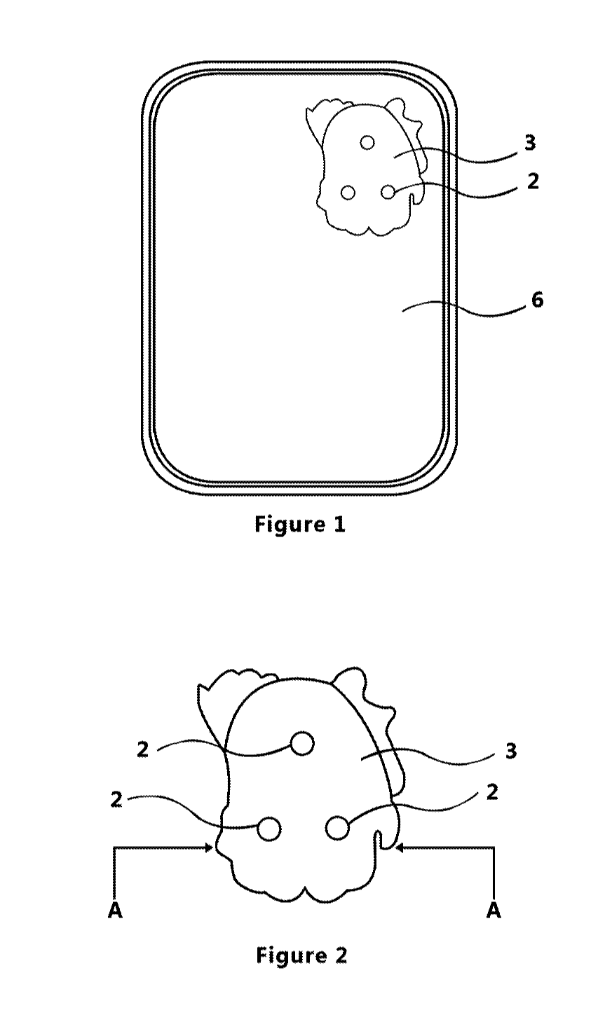

Application case I: as shown in FIG. 1, this is a blanket, which includes the blanket body 5. A decorative laminated patch with LED is connected with the upper surface of the blanket body. The decorative laminated patch with LED has the structure that a light emitting component is composed of a printed circuit board 1, 3 LED luminotrons, and a control circuit with a switch; the light emitting component is arranged in a plastic bag 3 with sealed periphery; the bottom of the plastic bag is a connection surface; the top is a decorative surface; and the position corresponding to the LED luminotron on the decorative surface is a transparent or semitransparent structure. The said LED luminotrons are red, green and yellow, respectively.

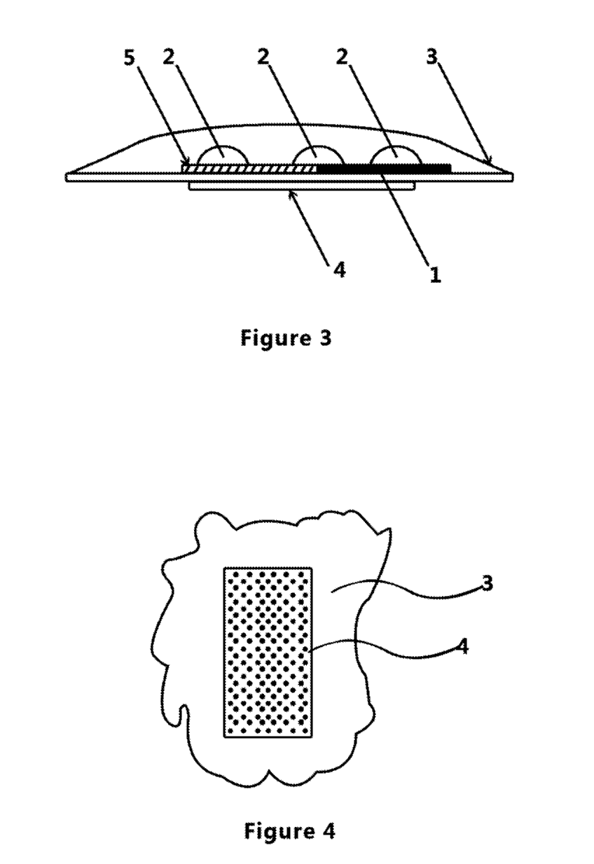

FIG. 2 to FIG. 4 are the schematic of the decorative laminated patch with LED in this application. In which, the upper surface of the said plastic bag is fixedly connected to the Velcro 4 either on the hook or the loop. And accordingly, the body of the said blanket is fixedly connected to the loop or hoop of the Velcro, and thus the decorative sheet is connected to the blanket body through the decorative sheet.

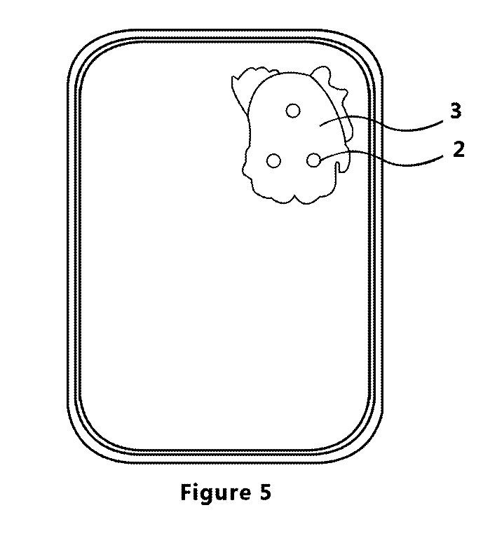

Application case II: as shown in FIG. 5, this is a blanket, which includes a blanket body. A decorative laminated patch with LED is connected with the upper surface of the blanket body. The decorative laminated patch with LED has the structure that a light emitting component is composed of a printed circuit board 1, three LED luminotrons 2, a sound circuit with a buzzer and a control circuit with a switch; the light emitting component is arranged in a plastic bag 3 with sealed periphery; the bottom of the plastic bag is a connection surface; the top is a decorative surface; and the position corresponding to the LED luminotron on the decorative surface is a transparent or semitransparent structure.

Of the decorative laminated patch with LED in the application case, the outside of the sealed periphery of the said plastic bag has the connection edge extending toward the surrounding, and the decorative laminated patch with LED will be fixedly sewn to the blanket body through the suture set on along the said connection edge.

1. A blanket, including the blanket body, is characterized in that the upper surface of the said blanket body is connected with a decorative laminated patch with LED; the structure of the said decorative laminated patch with LED is composed of a printed circuit board (1), at least one LED luminotron (2) and a control circuit with a switch, all of which compose a light emitting component; the above light emitting component is arranged in a plastic bag with sealed periphery(3); the bottom of this plastic bag is a connection surface, and the upper of which is a decorative surface, on which the corresponding location of the LED luminotron is of transparent or transparent structure.

2. As described, according to claim 1, the blanket is characterized in that the connection surface of the plastic bag is fixedly connected to either the hook or the loop of a Velcro; and the blanket body is fixedly connected to either the loop or the hook of a Velcro, and the decorative sheet is connected to the blanket body through the Velcro.

3. As described, according to claim 1, the blanket is characterized in that: the outside of the sealed periphery of the plastic bag has a connection extending to the surrounding, along the suture line of the connection edge the decorative sheet is fixedly sewn to the blanket body.

4. As described, according to claim 1, the blanket is characterized in that: the connection surface of the plastic bag and the blanket body are glued together through adhesive.

5. As described, according to claim 1, the blanket is characterized in that: the connection surface of the plastic bag and the blanket body are fixedly connected through snap buttons.

6. As described, according to claim 1, the blanket is characterized in that: the blanket body is fixedly configured with a transparent plastic bag open at one end, and a decorative laminated patch is placed in the transparent bag.

7. As described, according to claim 1, the blanket is characterized in that: it is equipped with 3 LED luminotrons, which are red, green and yellow, respectively.

8. As described, according to claim 1, the blanket is characterized in that: the printed circuit board is equipped with a sound circuit.

9. As described, according to claim 1, the blanket is characterized in that: the said control circuit is equipped with a delay-off circuit.
